(19) United States
(12) Patent Application Publication
(10) Pub. No.: US 2002/0148783 A1
(43) Pub. Date: Oct. 17, 2002

(54) Methods for purification of fluids

(75) Inventor: Sittichai Siriphraiwan, Poway, CA (US)

Correspondence Address: FOLEY & LARDNER, 402 WEST BROADWAY, 23RD FLOOR, SAN DIEGO, CA, 92101

(73) Assignee: Tru Industries, LLC

(21) Appl. No.: 10/162,771

(22) Filed: Jun. 4, 2002

Related U.S. Application Data
(63) Continuation-in-part of application No. 09/595,269, filed on Jun. 15, 2000.
(60) Provisional application No. 60/139,547, filed on Jun. 16, 1999.

(51) Int. Cl. B01D 61/02

(52) U.S. Cl. 210/652; 210/739; 210/748

(57) ABSTRACT

In accordance with the present invention, it has been discovered that exposure of a variety of fluids to electrical energy improves the purity thereof. In addition, exposure to electrical energy also imparts a variety of additional advantages to purification processes to which fluids are commonly subjected, such as, for example, reverse osmosis, filtration, liquid separation processes, and the like. For example, invention treatment may prolong the operating life of reverse osmosis membranes, may reduce the propensity of contaminants in fluid being treated to foul a membrane, may increase the flow rate of fluid through a membrane being used for the purification thereof, may reduce the volume of fluid required to produce a unit of treated fluid in a reverse osmosis process, may reduce the pressure required to transport fluid across a membrane being used for the treatment thereof, and the like.

### CROSS-REFERENCE TO RELATED APPLICATIONS

The present application is a continuation-in-part patent application of U.S. non-provisional application, entitled “LIQUID PURIFICATION SYSTEM, CONTROL SYSTEM AND CIRCUIT,” Ser. No. 09/595,269 filed on Jun. 15, 2000, now pending, which application is related to, and claims priority under 35 U.S.C. §119(e) of, U.S. provisional patent application Serial No. 60/139,547, titled “The Concept of Flushing/Cleaning Sequence for Liquid Separation/Purification System and The Flushing/Cleaning Sequence Control Circuit called FCS”, filed Jun. 16, 1999, which is hereby incorporated by reference in its entirety. The present application is filed on even date with an application having the title “LIQUID PURIFICATION SYSTEM AND COMPONENT AND METHOD OF USING SAME”, Ser. No. ______, the entire contents of which are hereby incorporated by reference herein.

### BACKGROUND OF THE INVENTION

1. Field of the Invention

The present invention relates to methods for purification of fluids. In a particular aspect, the invention relates to methods for purifying water. In another aspect, the invention relates to improved reverse osmosis processes, and the purified fluids produced thereby.

2. Related Art

There have been many types and kinds of liquid purification systems. For example, reference may be made to the following U.S. Pat. Nos. 4,851,818 to Brown et al; 4,956,083 to Tovar; 5,063,843 to Snee; 5,230,807 to Kozlowski, II; 5,281,330 to Oikawa et al; 5,480,555 to Momber; 5,518,608 to Chubachi; 5,597,479 to Johnson; 5,728,303 to Johnson, and 6,126,797 to Sato et al., which are each incorporated herein in their entirety by this reference as if fully set forth herein.

One popular approach for the purification of water is the reverse osmosis process. Such a process includes the use of a membrane filter to remove undesirable entrained particles. While such systems have proven to be effective, their maintenance and efficiency are disadvantageous for many applications. For example, conventional drinking water reverse osmosis systems used in the home produce, in some instances, only about six gallons of purified water in 24 hours. It would be highly desirous to improve the quantity of purified water which such systems can produce over a given period of time, such as a 24 hour period of time.

Also, such conventional reverse osmosis systems used in the home often times produce approximately one gallon of purified water from about five gallons of water to be purified. Thus, about four gallons of water are wasted. It would, of course, be greatly advantageous to have a much more efficient system to avoid the unwanted and undesirable waste of expensive water.

Additionally, such conventional reverse osmosis systems, when functioning at peak operational effectiveness at maximum recommended pressure, may be effective to remove unwanted particulates up to only about a 94% efficiency. However, as the process is carried out over extended periods of time, the membrane filter or other flow paths through which the treated fluid is to pass becomes clogged, and thus the efficiency of the process gradually becomes degraded, until the filter must be serviced.

Thus, it would be highly advantageous if the efficiency of reverse osmosis processes can be maintained or improved, with little or no degradation of system performance and the equipment employed therewith.

### BRIEF DESCRIPTION OF THE INVENTION

In accordance with the present invention, it has been discovered that exposure of a variety of fluids to electrical energy facilitates purification of such fluids. In addition, exposure to electrical energy also imparts a variety of additional advantages to purification processes to which fluids are commonly subjected, such as, for example, reverse osmosis, filtration, liquid separation processes, and the like. For example, invention treatment may prolong the operating life of reverse osmosis membranes, may reduce the propensity of contaminants in the fluid being treated to foul a membrane, may increase the flow rate of fluid through a membrane being used for the purification thereof, may reduce the volume of fluid required to produce a unit of treated fluid in a reverse osmosis purification process, may reduce the pressure required to transport fluid across a membrane being used for the treatment thereof, and the like.

### DESCRIPTION OF CERTAIN EMBODIMENTS OF THE INVENTION

In accordance with the present invention, there are provided methods for treating fluid(s) to improve the purity thereof, said methods comprising exposing said fluid(s) to sufficient electrical power to improve the purity thereof.

The exposure contemplated by the present invention can be accomplished in a variety of ways, as readily recognized by those of skill in the art. For example, two or more electrodes can be introduced into the fluid to be treated, and sufficient electrical power passed therebetween. It is presently preferred to use the system described in companion application Ser. No. ______, filed on even-date herewith, to introduce sufficient electrical energy into the fluid being treated.

The quantity of electrical energy contemplated for introduction into the fluid to be treated according to invention treatment methods can vary widely. As understood by those of skill in the art, electrical energy is the product of the voltage applied and the current of that voltage. Typically, the voltage of said electrical power falls in the range of about 3.5 up to about 20 volts. Typically, the current of said electrical power falls in the range of about 5 up to about 500 mAmps.

In order to prevent plating of contaminants on any of the electrodes employed in the practice of the present invention, it is presently preferred that the electrical power be applied to the fluid sample being treated in a multi-directional manner (i.e., not in one direction only, and not necessarily alternating). It is especially preferred that the electrical power be applied in an undulating pattern. As recognized by those of skill in the art, the frequency of undulation can vary widely, typically falling in the range of about 200 Hz up to about 40,000 Hz.

The frequency of electrical power applied to the feed fluid can be varied as a function of the level of impurities in the fluid being treated. To facilitate doing so, it is presently preferred that the level of impurities in the feed fluid being treated is monitored. As readily recognized by those of skill in the art, such monitoring can be carried out in a variety of ways, e.g., by monitoring the conductivity of the feed fluid, the resistivity of the feed fluid, calorimetrically, and the like.

In one aspect of the present invention, the frequency of electrical power applied to the feed fluid is increased in response to increasing levels of impurities in the fluid being treated. In another aspect of the present invention, the frequency of electrical power applied to the feed fluid is reduced in response to decreasing levels of impurities in the fluid being treated.

As readily recognized by those of skill in the art, a wide variety of fluids can be treated in accordance with the present invention. Exemplary fluids include water, ammonia, glucose, and the like. A presently preferred fluid for treatment according to the present invention is water.

In accordance with another embodiment of the present invention, there are provided methods for purifying water, said methods comprising exposing said water to an effective amount of electrical power as said water is contacted with a reverse osmosis membrane. Thus, the performance of reverse osmosis purification processes is improved by exposure of the fluids being treated to effective amounts of electrical energy as described herein.

Reverse osmosis processes are well known in the art. It is contemplated that any reverse osmosis process, regardless of the membrane employed, the column configuration employed, and the like, will benefit from application of the invention methodology.

In accordance with yet another embodiment of the present invention, there are provided methods for prolonging the operating life of a reverse osmosis membrane, said methods comprising exposing feed water to an effective amount of electrical power before said feed is contacted with said membrane. Alternatively, feed water can be exposed to an effective amount of electrical power at the same time as the feed is contacted with said membrane. Thus, the service life of a reverse osmosis membrane can be significantly increased by the invention method. This provides the economic benefit of reducing the cost of maintenance for the reverse osmosis equipment.

As readily recognized by those of skill in the art, reverse osmosis membranes must be replaced from time to time, due to fouling, decomposition, or other such factors which diminish the performance thereof. The frequency of such labor and cost requirement can be significantly reduced by implementing the invention process.

In accordance with still another embodiment of the present invention, there are provided methods for reducing fouling of a reverse osmosis membrane during reverse osmosis purification of water, said method comprising exposing feed water to an effective amount of electrical power before and/or during contacting of said membrane with said feed water. Thus, reverse osmosis equipment subjected to invention methods provide much better performance, with reduced maintenance requirements, as a result of the reduced fouling afforded by the invention methods.

As is well known in the art, reverse osmosis membranes tend to foul over time, and consequently require service and/or replacement from time to time. Invention methods greatly reduce the need for such service and/or replacement.

In accordance with another embodiment of the present invention, there are provided methods to reduce the volume of rejected contaminated fluid (commonly referred to in the art as “concentrate”) produced by a reverse osmosis purification process, said method comprising exposing feed fluid to an effective amount of electrical power before and/or during contacting of said feed fluid with the reverse osmosis membrane.

Thus, the invention process facilitates much more efficient separation of feed fluid from the treated fluid, thereby reducing the amount of total fluid required to obtain the desired amount of treated fluid.

In accordance with yet another embodiment of the present invention, there are provided methods to increase what is commonly known in the art as “recovery” produced by a reverse osmosis purification process, said method comprising exposing feed fluid to an effective amount of electrical power before and/or during contacting of said feed fluid with the reverse osmosis membrane. Thus, the invention process facilitates much more efficient conversion of feed fluid to treated fluid, thereby reducing the amount of total fluid required to obtain the desired amount of treated fluid.

In accordance with yet another embodiment of the present invention, it has been discovered that the pressure required for feed fluid to be transported across a reverse osmosis membrane is reduced as a result of invention treatment. Thus, by exposing feed fluid to an effective amount of electrical power before and/or during contacting of said membrane with said feed fluid, improved operating efficiencies are achieved. Thus, the operating conditions under which invention purification processes are carried out are significantly less demanding than the operating conditions under which prior art reverse osmosis processed are carried out. This can facilitate extended lifetimes for reverse osmosis membranes and reduced operating expenses.

In accordance with a further embodiment of the present invention, it has been discovered that invention methods provide increased flow rates of feed fluid through a reverse osmosis membrane during reverse osmosis purification of said fluid. This improved performance can be achieved by exposing feed fluid to an effective amount of electrical power before and/or during contacting of said membrane with said feed fluid. Thus, reverse osmosis purification carried out according to the invention provides substantially higher throughput without requiring additional equipment (or equipment of increased size). Stated another way, the capacity of a given reverse osmosis column can be increased according to the invention without increasing the size of the column itself.

In accordance with another embodiment of the present invention, there are provided purified fluid(s) produced by any of the above-described methods of the invention. Such fluids are substantially free of contaminants typically retained, albeit at relatively low levels, in fluids subjected to prior art purification processes.

While the invention has been described in detail with reference to certain preferred embodiments thereof, it will be understood that modifications and variations are within the spirit and scope of that which is described and claimed.

That which is claimed is:

1. A method for treating a fluid in a purification system, to improve the purification thereof, said method comprising exposing said fluid in said purification system to sufficient electrical power to improve the purification thereof.

2. A method according to claim 1 wherein said electrical power is applied in a multi-directional manner.

3. A method according to claim 2 wherein said electrical power is applied in an undulating pattern.

4. A method according to claim 3 wherein the voltage of said electrical power falls in the range of about 3.5 up to about 20 volts.

5. A method according to claim 3 wherein the current of said electrical power falls in the range of about 5 up to about 500 mAmps.

6. A method according to claim 3 wherein the frequency of undulation falls in the range of about 200 Hz up to about 40,000 Hz.

7. A method according to claim 1 wherein said fluid is water, ammonia, or glucose.

8. A method according to claim 1 wherein said fluid is water.

9. A method according to claim 1, wherein the frequency of electrical power applied to said feed fluid is varied as a function of the level of impurities in the fluid being treated.

10. A method according to claim 9 wherein the level of impurities in the feed fluid to be treated is monitored.

11. A method according to claim 10 wherein the frequency of electrical power applied to said feed fluid is increased in response to increasing levels of impurities in the feed fluid.

12. A method according to claim 10 wherein the frequency of electrical power applied to said feed fluid is reduced in response to decreasing levels of impurities in the feed fluid.

13. The purified fluid produced by the method of claim 1.

14. A method for purifying water, said method comprising exposing said water to an effective amount of electrical power as said water is contacted with a reverse osmosis membrane.

15. The purified fluid produced by the method of claim 14.

16. A method for prolonging the operating life of a reverse osmosis membrane, said method comprising exposing feed water to an effective amount of electrical power before and/or during contacting of said feed with said membrane.

17. A method for reducing fouling of a reverse osmosis membrane during reverse osmosis purification of water, said method comprising exposing feed water to an effective amount of electrical power before and/or during contacting of said membrane with said feed water.

18. A method to reduce the volume of rejected contaminants produced by a reverse osmosis purification process, said method comprising exposing feed water to an effective amount of electrical power before and/or during contacting of said feed water with the reverse osmosis membrane.

19. A method to increase the recovery of treated water produced by a reverse osmosis purification process, said method comprising exposing feed water to an effective amount of electrical power before and/or during contacting of said feed water with the reverse osmosis membrane.

20. The purified water produced by the method of claim 19.
